(19) United States
(12) Patent Application Publication
(10) Pub. No.: US 2018/0355505 A1
(43) Pub. Date: Dec. 13, 2018

(54) Concentration indicator of metal component contained in plating solution, and plating method using the same

(71) Applicant: BEFS CO., LTD., Daejeon (KR)

(72) Inventors: Seung Jin Lee, Yongin (KR); Chang Hyeok Bang, Seoul (KR); Dae Yeong Yun, Seoul (KR)

(21) Appl. No.: 15/998,463

(22) Filed: Aug. 15, 2018

Related U.S. Application Data
(63) Continuation of application No. PCT/KR2017/000447, filed on Jan. 13, 2017.

(30) Foreign Application Priority Data
Feb. 15, 2016 (KR) 10-2016-0017431

(51) Int. Cl. C25D 21/18; C25D 3/56; G01N 31/22

(52) U.S. Cl. CPC C25D 21/18; G01N 31/22; C25D 3/56

(57) ABSTRACT

The present invention relates to a concentration indicator of a metal component contained in a plating solution and a plating method using the same and, more specifically, as the concentration of a plating metal component to be plated is lowered, the color of the plating solution is changed to visually indicate a change in concentration, and thus a worker can readily manage the concentration of a metal component contained in a plating solution within a short time. In addition, whether a plating metal component should be replenished can be determined in real-time so as to enable the precision and reliance of plating work to be improved, workability is improved by continuous maintenance, and cost is reduced.

### CROSS-REFERENCE TO RELATED APPLICATIONS

This application is a continuation application of International Application No. PCT/KR2017/000447 filed on Jan. 13, 2017, which claims priority to Korean Patent Application No. 10-2016-0017431 filed on Feb. 15, 2016. The applications are incorporated herein by reference in their entirety.

### TECHNICAL FIELD

The present invention relates to an indicator of the in-liquid concentration of a metal component contained in a plating solution and a plating method using the indicator. More particularly, the present invention relates to an indicator of the in-liquid concentration of a metal component contained in a plating solution and a plating method using the indicator, with which the color of the plating solution is changed as the concentration of the plating metal component is decreased, and the change in concentration is made visually observable, so that the operator may readily manage the concentration of the metal component contained in the plating solution.

### RELATED ART

Plated steel sheets not only offer an aesthetic appearance but also provide advantages in terms of corrosion resistance, weldability, and paintability, and as such are widely used as materials for automobiles, household appliances, etc. In minimizing the defect rate of such plated steel sheets, controlling the concentration of the plating solution for manufacturing the plated steel sheets is an essential requirement. Thus, concentration control based on an analysis of the plating solution may have a large impact on the quality, etc., of the plated steel sheet.

In the related art, such control may entail an operator arbitrarily taking a sample of the plating solution during the plating process, manually analyzing the sample, and additionally supplying a plating solution of a particular composition and concentration if there is a need to modify the composition of the plating solution. However, with advances in industrial technology and corresponding demands for increasingly higher plating quality, the maintaining of the plating solution at a suitable condition with respect to the purity and concentration of the plating solution is becoming a burden at the production site.

With the above-mentioned method that requires an operator taking a sample arbitrarily during the plating process and analyzing and managing the plating solution manually, it is practically impossible to guarantee the levels of precision and reliability of the plating process. Providing high levels of precision and reliability for the plated steel sheets would require continuous attention and care on the part of the operator, requiring intensive manual labor and yielding significantly low workability.

In particular, managing the concentration of the plating metal component within the plating solution is very important, because as the plating progresses, the plating metal component within the plating solution is gradually expended and gradually lowered in concentration, so that in order to maintain a constant plating speed and a uniform plating quality, the concentration of the plating metal component must be maintained.

A generally used method of analyzing a plating solution is known as the CV (cyclic voltammetric) method or CVS (cyclic voltammetric stripping) method, which finds the concentration by measuring the amount of copper deposited on a rotating cathodic electrode. This method, however, does not analyze the concentration of an individual component but rather only indirectly manages the concentration through an overall change in electrical potential, so that it may be difficult to manage the concentration in a precise manner, and the reproducibility may be low. Also, since the amount to be mixed in is determined beforehand for each of the components, it may not be easy to respond in real time to problems that occur when the balance in the amounts of components expended is lost due to changes in time, etc., affecting the plating conditions.

For analyzing a component of a trace amount in the plating solution, an analysis device using ultraviolet spectrophotometry may be used. This device may first scan the plating solution with an ultraviolet spectrophotometer to check the characteristic absorption wavelength and dilution ratio, prepare a blank test solution and a calibration curve, and use these to obtain the content of an organic additive in the plating solution.

Korean Registered Patent No. 0828482 (May 13, 2008) relates to a device for automatically analyzing and controlling an electroless composite plating solution and discloses an analysis device that irradiates beams of two or more wavelengths to measure the transmissivity or absorbance and then uses spectrophotometry and computational processing to find the in-liquid concentration of a metal component in a plating solution.

However, with the prior art document above, the analyzing of a metal component in a plating solution using spectrophotometry and computational processing may not only decrease the level of precision but also require time for the analysis, making it difficult to respond in real time to changes in concentration, etc., of the metal component.

### SUMMARY

The present invention aims to provide an indicator of the in-liquid concentration of a metal component contained in a plating solution and a plating method using the indicator, which visually display a change in concentration through a change in color of the plating liquid as the concentration of the plating metal component in the plating solution is decreased, thereby allowing the operator to readily manage the concentration of the plating metal component in the plating solution and determine whether or not to replenish the plating metal component during the plating process.

To achieve the objective above, an aspect of the present invention provides an indicator of the in-liquid concentration of a metal component contained in a plating solution, where the indicator can change the color of the plating solution at or below a particular concentration of a plating metal component, to enable the determining of whether or not the plating metal component in the plating solution used during a plating process is to be replenished.

The plating solution may preferably contain at least one or more additive selected from a group consisting of a chelating agent, a stabilizing agent, a reducing agent, and an organic acid in the plating metal precursor that is to be plated, and the indicator may preferably be reduced so as to change the color of the plating solution, after the plating metal component included in the plating metal precursor is expended.

The indicator can include a phenol-based compound expressed by Formula (1) below:

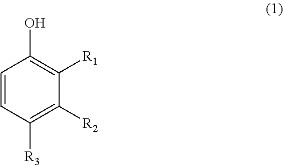

where, in said Formula 1, R1˜R3 represent a hydrogen atom, a hydroxy group, a carboxyl group, and a straight-chain or branched-chain alkyl group having a carbon number of 1 to 4.

The plating solution can further include an amide-based compound.

Another embodiment of the present invention provides a plating method that includes: a preparation step of preparing a plating solution containing an indicator of the in-liquid concentration of a metal component contained in a plating solution, where the indicator may be configured to change the color of the plating solution at or below a particular concentration of a plating metal component so as to enable the determining of whether or not the plating metal component in the plating solution used during a plating process is to be replenished; a plating step of immersing an electrode in the plating solution and applying plating using an electric current; a color change step in which the plating solution is changed in color as the indicator is reduced by way of electrons discharged from the electrode when the plating metal component in the plating solution is expended; and a replenishing step of replenishing the plating metal component in the plating solution.

The indicator can include a phenol-based compound expressed by Formula (1) below:

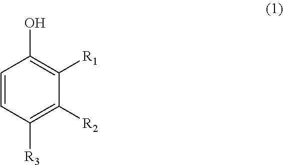

where, in said Formula 1, R1˜R3 represent a hydrogen atom, a hydroxy group, a carboxyl group, and a straight-chain or branched-chain alkyl group having a carbon number of 1 to 4.

The plating step may preferably have the plating applied at a temperature of 10˜30° C. and a current density of 3˜20.0 A/dm².

The present invention relates to an indicator of the in-liquid concentration of a metal component contained in a plating solution and a plating method using the indicator, where, when the concentration of the plating metal component is decreased, the color of the plating solution is changed to make the change in concentration visually observable, so that the operator may readily manage the concentration of the metal component contained in the plating solution within a short period of time.

As it is possible to determine in real time whether or not the plating metal component should be replenished, the precision and reliability of the plating operation can be improved, the workability associated with continuous maintenance can be improved, and the required costs can be decreased.

### DETAILED DESCRIPTION

Before providing a detailed description based on preferred embodiments of the present invention, it is hereby noted that the terms or words used in the specification and scope of claims are not to be limited in their interpretation to common or dictionary meanings but rather are to be interpreted as having meanings and concepts that agree with the technical spirit of the present invention.

In the entirety of the specification, mention of a certain part “including” a certain element does not preclude the existence of other elements and means that other elements can be included additionally, unless specifically stated otherwise.

In describing steps, reference numerals are used merely for the sake of convenience and do not describe the order of the steps. The steps can be practiced in an order different from the order disclosed herein, unless there is a specific order clearly disclosed in the context. That is, the steps can be practiced in the same order as that disclosed herein or can be practiced at substantially the same time or can be practiced in inverse order.

In the specification, a color change refers to a change from a colored state to a colorless state, from a colorless state to a colored state, or from a colored state to a colored state of a different color.

Below, a more detailed description is provided of an indicator of the in-liquid concentration of a metal component contained in a plating solution and a plating method using the indicator according to the present invention.

Generally, in a plating process, when a plating metal component contained in a plating solution begins to be plated onto an electrode because of an electric current, the plating metal component contained in the plating solution is expended, and the concentration is gradually lowered. Therefore, in order to maintain the plating speed and plating quality, the plating metal component has to be continuously replenished in the plating solution.

An indicator of the in-liquid concentration of a metal component contained in a plating solution according to an embodiment of the present invention, in order to enable an operator to determine whether or not the plating metal component expended during the plating process should be replenished, may change the color of the plating solution when the plating metal component in the plating solution reaches or drops below a particular concentration. To be more specific, when the plating metal component begins to be plated at the surface of the electrode due to an electric current, the plating metal component contained in the plating solution may gradually be expended, and as the plating metal component within the plating solution becomes insufficient, the electrons discharged through the electrode may reduce the indicator contained in the plating solution, causing the plating solution to change color.

This causes a visible color change in the plating solution, and when the plating metal component is replenished into the plating solution, the indicator may have the property of a reducing agent, so that the indicator may discharge electrons and be oxidized, whereby the plating solution can return to the color before the change.

The above series of events can occur repeatedly and continuously according to the concentration of the plating metal component within the plating solution. This can improve workability, since the operator is able to visually recognize changes in the concentration of the plating metal component in the plating solution, and a uniform quality management of the plating can be achieved, based on continued maintenance of the plating solution.

The indicator may preferably include a phenol-based compound expressed by Formula (1) below:

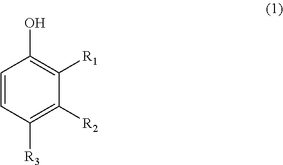

where, in Formula 1, R1˜R3 represent a hydrogen atom, a hydroxy group, a carboxyl group, and a straight-chain or branched-chain alkyl group having a carbon number of 1 to 4.

The phenol-based compound represented by Formula 1 can preferably be one or more compound selected from a group consisting of phenol, o-cresol, p-cresol, o-ethylphenol, p-ethylphenol, t-butylphenol, hydroquinone, catechol, pyrogallol, and methyl hydroquinone.

Also, a compound corresponding to an oxidized or a reduced form of the phenol-based compound represented by Formula 1 can also be used as an in-liquid indicator of metal component concentration in a plating solution according to the present invention.

It may be more preferable that the phenol-based compound expressed as Formula 1 above be included in a quantity of 0.1˜10 ml/L per IL of plating solution, since a content of the phenol-based compound less than 0.1 ml/L may not be a sufficient amount in the plating solution, so that the change in color of the plating solution may not be distinctly observable when the plating metal component in the plating solution drops to or below the particular concentration, whereas a content of the phenol-based compound more than 10 ml/L may not provide chemical stability in the plating solution.

The indicator of the in-liquid concentration of a metal component contained in a plating solution according to the present invention is not limited in terms of what types of plating solution the indicator may be used in, and can be added to and used for any plating solution generally used in a process for plating, such as electrolytic plating solutions, electroless plating solutions, alloy plating solutions, etc.

Preferably, the plating solution can include at least one or more additive selected from a group consisting of a chelating agent, a stabilizing agent, a reducing agent, and an organic acid.

For the chelating agent, DL-tartaric acid, citric acid, sodium citrate, potassium citrate, ammonium citrate, etc., can be used.

For the stabilizing agent, which stabilizes the plating solution or prevents decomposition, a sulfur-containing compound, oxycarboxylic acid, a nitrogen compound, a cyanide compound, a boron-based compound, etc., can be used.

A reducing agent may be included to provide a high covering power by using both chemical reduction and electrical reduction obtained through the reducing agent during plating, since it may be difficult to provide a high covering power purely with the reducing power of electricity if the metal that is to be plated has a low electrical conductivity. For the reducing agent, a hypophosphite compound and a boron compound, or formaldehyde, glyoxylic acid, hydrazine, etc., can be used.

More preferably, a plating solution according to the present invention can further include an amide-based compound as a plating solution for forming a lead-titanium-zirconium (PTZ) alloy layer. In this case, the plating solution would not be limited to a particular type as long as it is capable of forming a lead-titanium-zirconium (PTZ) alloy layer, and the plating solution can include the components mentioned above as is common and can also further include an indicator of the in-liquid concentration of a metal component contained in the plating liquid according to the present invention.

For the amide-based compound, any amide-based compound having an amide in the molecule can be used without limit. The amide-based compound not only can increase the deposition speed during the plating process but also can improve the appearance and adhesiveness of the plating as well as increase the chemical stability of the plating solution, so that the internal stresses of the plating layer may be effectively decreased, and hardness may be enhanced.

For the amide-based compound, an aliphatic amide-based compound such as dimethylformamide, N,N-Dimethylacetamide, alkoxy-N-isopropyl-propionamide, hydroxyalkylamide, etc., or an alicyclic amide-based compound such as N-methyl-2-pyrrolidone, N-ethyl-pyrrolidone, etc., can preferably be used.

A plating solution for forming the lead-titanium-zirconium (PTZ) alloy layer may be prepared by reacting metal ingredients, i.e. lead hydroxide, titanium hydroxide, zirconium hydroxide having a —OH group bonded therein, preferably in a powder form, with sulfuric acid, so that the solution can be easily dissolved in water and can exist in an ionized state in a stable manner.

The mixture proportions of the lead hydroxide, titanium hydroxide, zirconium hydroxide for forming the lead-titanium-zirconium (PTZ) alloy layer may preferably be 5˜25 parts by weight of titanium hydroxide and 10˜50 parts by weight of zirconium hydroxide per 100 parts by weight of lead hydroxide. If the proportions lie beyond the ranges above, the strength of the lead-titanium-zirconium (PTZ) alloy may be weakened, or the plating process may not be performed smoothly due to the electrical conductivity values of the lead, titanium, and zirconium components. Also, in consideration of the quality of the plating layer, the amount of water included in the lead hydroxide, titanium hydroxide, and zirconium hydroxide may preferably be 70˜85 wt %.

Also, fluoroboric acid, boric acid, and gelatin can be added as a stabilizing agent, reducing agent, etc., to the plating solution for forming the lead-titanium-zirconium (PTZ) alloy layer, and the indicator of the in-liquid concentration of a metal component contained in the plating solution according to the present invention can be included as well.

The contents of the fluoroboric acid, boric acid, gelatin, and the indicator of the in-liquid concentration of a metal component contained in the plating solution according to the present invention can preferably be, with respect to 100 parts by weight of fluoroboric acid, 1˜3 parts by weight of gelatin, 1˜10 parts by weight of the indicator, and an amount of boric acid that achieves a saturated state in serving as a stabilizing agent and reducing agent.

In addition to the components above, a plating solution according to the present invention can further include a pH adjusting agent. The pH adjusting agent can be selected, for example, from sulfuric acid, hydrochloric acid, sodium hydroxide, potassium hydroxide, etc. With the addition of such pH adjusting agent, a plating solution according to the present invention can have, for example, a pH of 0.1˜4. Also, a plating solution based on the present invention can further include other components according to the plating method.

A plating method according to the present invention may proceed as a common plating process, but any method that uses a plating solution based on the present invention as described above would be encompassed by the present invention. For example, an electroplating (electrolytic plating) process can be used, following the typical process for electroplating, but with a plating solution based on the present invention described above provided in the plating bath for the electroplating.

To be more specific, the plating can include a preparation step of preparing a plating solution containing an indicator of the in-liquid concentration of a metal component contained in a plating solution, where the indicator may be configured to change the color of the plating solution at or below a particular concentration of the plating metal component so as to enable the determining of whether or not the plating metal component in the plating solution used during a plating process is to be replenished, a plating step of immersing an electrode in the plating solution and applying plating using an electric current, a color change step in which the plating solution is changed in color as the indicator is reduced by way of electrons discharged from the electrode when the plating metal component in the plating solution is expended, and a replenishing step of replenishing the plating metal component in the plating solution.

A detailed description of the indicator of the in-liquid concentration of a metal component contained in the plating liquid has already been provided above and thus is not repeated here.

Here, it may be preferable that, in the plating step, the plating be performed under the conditions of 10˜30° C. temperature and 3˜20.0 A/dm² current density.

Also, with the present invention, there is no limit on the object being plated.

An object being plated refers to a target of the plating or alloy plating using a plating solution of the present invention, and the concept may include finished products, partly finished products, or elements used for manufacturing finished or partly finished products. The object being plated can be of a single metal, for example aluminum (Al), magnesium (Mg), iron (Fe), copper (Cu), etc., or an alloy containing one or more metal selected from the above, or can be of a plastic material.

Furthermore, the present invention can be applied to decorative processes or fine precision processes for common products. For example, the present invention can be applied in the LIGA process, etc., of MEMS for forming 3-dimensional structures or micro-patterns (or nano-patterns); there is no limit to the field of application.

According to the present invention set forth above, the internal stresses of the plating layer can be significantly decreased by the amide-based compound, as described above. Moreover, the surface hardness, etc., of the plating layer can be increased, thus providing a plating surface of a high quality.

A specific embodiment of the present invention is provided below. However, the scope of the present invention is not limited by the preferred embodiment set forth below, and the skilled person would be able to derive several variations from the disclosure of the present specification without departing from the scope of rights of the present invention.

### [Example] Lead-Titanium-Zirconium Alloy Plating Process

An alloy solution was prepared by reacting sulfuric acid with a mixture containing 100 g of lead hydroxide (water content 75.45%), 32.03 g of zirconium hydroxide (water content 79.68%), and 16.67 g of titanium hydroxide (water content 82.94%), so that the components may easily dissolve in water and exist in an ionized state. Then, 100 g of fluoroboric acid, 5 g of hydroquinone, and 0.2 g of gelatin were mixed in, boric acid was added to saturation, and the preparation was mixed with the alloy solution to prepare an alloy plating solution.

The prepared alloy plating solution was placed in a plating bath, and plating was performed by applying a current of 7.0 A/dm² to the anode (Sn 10%, Pb 90% vinyon back) at normal temperature (25° C.) and at a pH of 0.9.

The prepared alloy plating solution was initially colorless, but as the hydroquinone, which has a strong reducing property, generates quinone through redox reactions, the alloy plating solution became colored (red).

The alloy was evenly plated on one side of the anode, and as time passed, it was observed that the plating solution changed from a colored (red) state to a transparent state, and as such, the alloy metal compound containing lead hydroxide, zirconium hydroxide, and titanium hydroxide that was reacted with sulfuric acid in the plating solution was replenished.

When the alloy metal compound was replenished, it was observed that the plating solution returned again to a colored (red) state.

Thus, an indicator of the in-liquid concentration of a metal component contained in a plating solution based on the present invention can help an operator to easily and effectively manage the concentration of a metal component included in the plating solution in a short period of time, by changing the color of the plating solution when the concentration of the plating metal component to be plated on is decreased, so that the change in concentration is visibly observable.

The present invention relates to an indicator of the in-liquid concentration of a metal component contained in a plating solution and a plating method using the indicator, where, when the concentration of the plating metal component is decreased, the color of the plating solution is changed to make the change in concentration visually observable, so that the operator may readily manage the concentration of the metal component contained in the plating solution. As it is possible to determine in real time whether or not the plating metal component should be replenished, the present invention offers industrial applicability in that the precision and reliability of the plating operation can be improved, the workability associated with continuous maintenance can be improved, and the required costs can be decreased.

What is claimed is:

1. An indicator of an in-liquid concentration of a metal component contained in a plating solution, the indicator characterized by changing a color of the plating solution at or below a particular concentration of a plating metal component, to enable a determining of whether or not the plating metal component in the plating solution used during a plating process is to be replenished.

2. The indicator of an in-liquid concentration of a metal component contained in a plating solution according to claim 1, wherein the plating solution contains, in a plating metal precursor to be plated, at least one or more additive selected from a group consisting of a chelating agent, a stabilizing agent, a reducing agent, and an organic acid,
and the indicator is reduced so as to change the color of the plating solution, after a plating metal component included in the plating metal precursor is expended.

3. The indicator of an in-liquid concentration of a metal component contained in a plating solution according to claim 1, wherein the indicator comprises a phenol-based compound expressed by Formula (1) below: 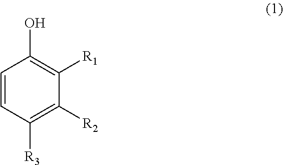
where, in said Formula 1, R1˜R3 represent a hydrogen atom, a hydroxy group, a carboxyl group, and a straight-chain or branched-chain alkyl group having a carbon number of 1 to 4.

4. The indicator of an in-liquid concentration of a metal component contained in a plating solution according to claim 1, wherein the plating solution further comprises an amide-based compound.

5. A plating method comprising:
a preparation step of preparing a plating solution containing an indicator of an in-liquid concentration of a metal component contained in the plating solution, the indicator configured to change a color of the plating solution at or below a particular concentration of a plating metal component so as to enable a determining of whether or not the plating metal component in the plating solution used during a plating process is to be replenished;
a plating step of immersing an electrode in the plating solution and applying plating using an electric current;
a color change step of having the plating solution change color as the indicator is reduced by way of electrons discharged from the electrode when the plating metal component in the plating solution is expended; and
a replenishing step of replenishing the plating metal component in the plating solution.

6. The plating method of claim 5, wherein the indicator comprises a phenol-based compound expressed by Formula (1) below: 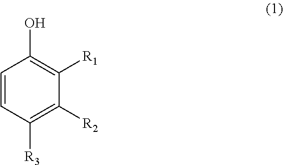
where, in said Formula 1, R1˜R3 represent a hydrogen atom, a hydroxy group, a carboxyl group, and a straight-chain or branched-chain alkyl group having a carbon number of 1 to 4.

7. The plating method of claim 5, wherein the plating step comprises applying plating at a temperature of 10˜30° C. and a current density of 3˜20.0 A/dm².
